(19) United States
(12) Patent Application Publication
(10) Pub. No.: US 2002/0046585 A1
(43) Pub. Date: Apr. 25, 2002

(54) Recycled fertilizer and method for producing the same

(75) Inventors: Takashi Ishikawa, Higashine-shi (JP); Ryuichi Takahashi, Yamagata-shi (JP)

Correspondence Address: KANESAKA AND TAKEUCHI, 1423 Powhatan Street, Alexandria, VA, 22314, US

(73) Assignee: IG-Technical Research Inc.

(21) Appl. No.: 09/919,811

(22) Filed: Aug. 2, 2001

(30) Foreign Application Priority Data
Sep. 4, 2000 (JP) 2000-266928
Sep. 4, 2000 (JP) 2000-266929
Mar. 28, 2001 (JP) 2001-092810

(51) Int. Cl. C05D 9/00

(52) U.S. Cl. 71/62; 71/31

(57) ABSTRACT

A waste of asbestos-containing inorganic building materials is reacted and burnt at a temperature in a range of 600° C. to 1,500° C. to obtain a recycled silicic acid type fertilizer with decomposed asbestos. Thus, the asbestos contained in the inorganic building material waste, which is said to be harmful to the health, is decomposed and recycled as the silicic acid type fertilizer.

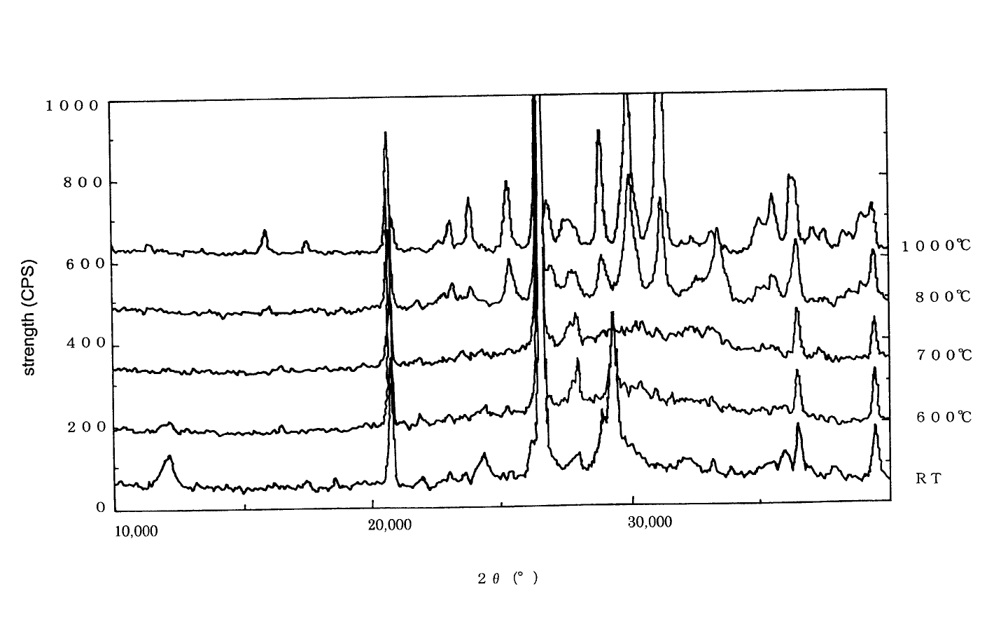

### BACKGROUND OF THE INVENTION AND RELATED ART STATEMENT

This invention relates to a recycled silicic acid type fertilizer obtained by subjecting the waste of asbestos-containing inorganic type building materials to reaction and burning to thereby decompose the asbestos. Also, this invention relates to a method for manufacturing the silicic acid type fertilizer useful for cultivation of the gramineous plant by burning the asbestos-containing inorganic type building materials to thereby decompose the asbestos component.

The building materials containing asbestos represented by chrysotile, which is said to be harmful to the health, have been used over 30 years as the roof materials and wall materials of residence buildings and non-residence buildings. Recently, while the asbestos contents have been gradually reduced, the contents do not become zero. Also, the building materials containing a lot of asbestos which were manufactured in the past have been still used for the residence buildings. Therefore, various problems relating to asbestos have been caused as the building materials are deteriorated. Especially, a treating method effective for the waste of the building materials has not been established.

As a waste treating method of the asbestos building materials, there are only treating methods, for example, the waste in a large mass is buried in the ground, or after the waste is melted in a furnace at a temperature of more than 1,500° C. to solidify, the solidified waste is buried in a final stable treating place.

The asbestos-containing building materials have been left as they are without a useful treating method, which has been an object of public concern. Thus, a specific and useful treating method has been anticipated. On the other hand, a silicic acid type fertilizer has been attracting the public attention as a fertilizer useful for increasing silicified cells of gramineous plants, especially, rice plant and elevating a disease endurance, insect resistance, lodging resistance and the like. Slag silicic acid type fertilizers produced from a phosphorus production residual slag and an iron production residual slag are represented as the silicic acid type fertilizer. The slag silicic acid type fertilizer is produced from impurities in a specific producing process, so that there has been a problem that harmful components, such as nickel, chromium and titanium, are contained therein though the contents are in a small quantity.

In view of the above problems, the present invention has been made, and an object of the invention is to provide a recycled silicic acid type fertilizer from the waste of the asbestos-containing inorganic type building materials.

Another object of the invention is to provide a method for producing the recycled silicic acid type fertilizer.

Further objects and advantages of the invention will be apparent from the following description of the invention.

### SUMMARY OF THE INVENTION

The waste of inorganic building materials containing asbestos which is said to be harmful to the health is subjected to reaction and burning at a temperature higher than 600° C. to decompose the asbestos and, further, silicon contained in the building materials is recycled to produce a silicic acid type fertilizer. However, in the present invention, the waste of the inorganic building materials contains almost no harmful components, such as nickel, chromium and titanium.

Also, the present invention provides a method for producing the silicic acid type fertilizer with decomposed asbestos useful for cultivation of the gramineous plant by burning the asbestos-containing inorganic type building materials.

### DETAILED DESCRIPTION OF THE PREFERRED EMBODIMENT

The asbestos-containing inorganic building materials used in the present invention mainly include asbestos and at least one of cement and calcium silicate, and include almost no harmful components, such as nickel, chromium and titanium. The inorganic building material may be an inorganic building material mainly including asbestos and at least one of cement, slate and calcium silicate. For example, there are mentioned a flat-type saturation slate, wave-type saturation slate, slate, calcium silicate plate, slag plaster plate, ceramic type siding and the like. Although these include wastes of roof materials and wall materials containing asbestos caused by mainly replacement and rebuilding, naturally, those which are not so used are also included.

Since the asbestos-containing inorganic building materials produced by replacement and rebuilding are already deteriorated and are liable to scatter asbestos, when collection, transportation and storage thereof are carried out, special attention must be paid.

It is desirable to subject the building material waste to the reaction and burning at a temperature in a range of from 600° C. to 1,500° C. When the reaction and burning are carried out at a temperature higher than 600° C., a peak of asbestos is absent, while when the reaction and burning are carried out at a temperature higher than 1,500° C., asbestos melts. Of course, the burning temperature is determined by taking a fuel cost, workability, equipment and the like into consideration. Although there are various burning methods, it is preferable that the waste building materials are burnt in a tunnel kiln in a laminated state without crushing as much as possible to prevent asbestos from being scattered. However, taking a fuel cost and the like into consideration, the waste building materials may be crushed to some extent and then subjected to the burning.

Although time required for burning the waste is not especially limited, it is desirable that a peak of asbestos contained in the waste building materials be absent through an X-ray diffraction, which can be determined by a size and laminating method of the waste building materials.

The substance burnt at a temperature higher than 600° C. does not show the peak of asbestos through the X-ray diffraction thereby not to confirm existence of asbestos. Also, when the soluble silicic acid and alkaline component are analyzed, it is found that the analysis fits the silicic acid type fertilizer having an official standard of a normal fertilizer. The magnesia component contained in asbestos is found to be effective as a fertilizer component.

The particle size may be adjusted by pulverizing after the burning. However, in case the particle size is too small as the fertilizer, water may be properly added to the particles to produce pelletized or granulated substances.

Also, in case a lime component is required, it is possible to adjust by adding at least one of quicklime and hydrated lime. Further, effective components of other fertilizers may be added. Especially, those components may be added in a granulating or pelletizing process to thereby obtain granulated or pelletized substances.

In case alkaline is too strong, it is possible to easily adjust pH thereof through a carbonating treatment.

### EXAMPLE 1

About 5 kg of flakes of asbestos containing building material (Tradename: COLONIAL, the composition is shown in Table 1) waste were subjected to reaction and burning for 15 minutes at about 1,000° C. and pulverized in a mill. The obtained burnt pulverized substance did not show the asbestos peak through the X-ray diffraction and was analyzed to obtain results as shown in Table 2. In other words, it contained 35.7% of alkaline component and 18.9% of soluble silicate, which fit the numeral values of the official standard as a silicic acid type fertilizer. Also, since the alkaline component was 35.7% and soluble magnesia was 5.7%, the burnt pulverized substance fits the numeral values of a mixed lime fertilizer assuring the soluble magnesia.

TABLE 1

| Base material composition of | |
|---|---|
| asbestos containing building | Parts |
| material | by wt. |
| Asbestos | 20 |
| Cement | 39 |
| Fine silica sand | 26 |
| Reduction scraps | 15 |
| Total | 100 |

TABLE 2

| Item | Analyzed Results |
|---|---|
| pH (H₂O) | 11.1 |
| Soluble silicic acid (0.5 M | 18.9% |
| hydrochloric acid solubility) | |
| Soluble lime (0.5 M | 27.8% |
| hydrochloric acid solubility) | |
| Soluble magnesia (0.5 M | 5.7% |
| hydrochloric acid solubility) | |
| Alkaline component | 35.7% |

Analyzing Method:
pH(H₂O): glass electrode method
Soluble silicic acid: potassium fluoride method
Soluble lime: atomic absorption spectrometry
Soluble magnesia: atomic absorption spectrometry

According to the invention, the following advantages can be obtained: 1) asbestos which is said to be harmful for the health not only can be decomposed but also be effectively recycled; 2) since the waste can be recycled as a fertilizer, there is a great demand; 3) a silicic acid type fertilizer containing almost no harmful components, such as nickel, chromium and titanium, can be obtained; and 4) the fertilizer obtained in the invention can be used as not only a silicic acid type fertilizer but also a mixed lime fertilizer for assuring soluble magnesia.

While the invention has been explained with reference to the specific example of the invention, the explanation is illustrative and the invention is limited only by the appended claims.

What is claimed is:

1. A silicic acid type fertilizer with a decomposed asbestos component obtained by reacting and burning an inorganic type building material mainly comprising asbestos and at least one of cement and calcium silicate at a temperature higher than 600° C.

2. A silicic acid type fertilizer as claimed in claim 1, wherein said inorganic building material comprises asbestos and at least one of cement, slate and calcium silicate.

3. A method for producing a silicic acid type fertilizer comprising,
burning an asbestos-containing inorganic type building material to obtain a silicic aid type fertilizer with a decomposed asbestos by reacting and burning said inorganic type building material mainly including asbestos and at least one of cement and calcium silicate at a temperature higher than 600° C.

4. A method as claimed in claim 3, wherein said temperature is within the range from above 600° C. to about 1,500° C.

5. A method as claimed in claim 4, wherein said building material includes asbestos and at least one of cement, slate and calcium silicate.
